(19) United States
(12) Patent Application Publication
(10) Pub. No.: US 2026/0138510 A1
(43) Pub. Date: May 21, 2026

(54) BLOCKER MECHANISM FOR VEHICLE SEAT

(71) Applicant: Camaco, LLC, Farmington Hills, MI (US)

(72) Inventors: Jeff Carroll, West Bloomfield, MI (US); Selvakumaresan Veluswamy, Farmington Hills, MI (US); Pradeep Akkineni, Farmington Hills, MI (US)

(73) Assignee: Camaco, LLC, Farmington Hills, MI (US)

(21) Appl. No.: 19/394,607

(22) Filed: Nov. 19, 2025

Related U.S. Application Data
(60) Provisional application No. 63/722,845, filed on Nov. 20, 2024.

(51) Int. Cl. B60N 2/30

(52) U.S. Cl. CPC B60N 2/3088; B60N 2/3009; B60N 2/305; B60N 2205/30

(57) ABSTRACT

A vehicle seat includes a seat bottom assembly and a seat back. The seat bottom assembly includes a base, a seat bottom, a connector movably coupling the seat bottom to the base, and a latching mechanism coupled to the base. The latching mechanism includes a latch receiver positioned to receive a latch interface installed in a vehicle and a latch retainer pivotably coupled to the base. The latch retainer is positioned to selectively prevent removal of the latch interface from the latch receiver. The seat back is pivotably coupled to the base. The vehicle seat is reconfigurable between a seat configuration and a stowed configuration. When transitioning the vehicle seat from the seat configuration to the stowed configuration, the seat bottom moves relative to the base, causing the connector to engage with the latch retainer, permitting disengagement of the latch receiver from the latch interface.

### CROSS-REFERENCE TO RELATED APPLICATIONS

This application claims the benefit of and priority to U.S. Provisional Patent Application 63/722,845, filed Nov. 20, 2024, which is incorporated herein by reference in its entirety.

### BACKGROUND

A vehicle may include a cabin that has a seat assembly that accommodates and supports an occupant. The seat assembly includes an upper frame and a lower frame that pivotably couples the upper frame to the lower frame.

### SUMMARY

One embodiment relates to a vehicle seat. The vehicle seat includes a seat bottom assembly and a seat back. The seat bottom assembly includes a base, a seat bottom, a connector movably coupling the seat bottom to the base, and a latching mechanism coupled to the base and configured to engage with a latch interface installed in a vehicle. The latching mechanism includes a latch receiver positioned to receive the latch interface and a latch retainer pivotably coupled to the base. The latch retainer is positioned to selectively prevent removal of the latch interface from the latch receiver. The seat back is pivotably coupled to the base. The vehicle seat is reconfigurable between a seat configuration and a stowed configuration. When transitioning the vehicle seat from the seat configuration to the stowed configuration, the seat bottom moves relative to the base, causing the connector to engage with the latch retainer, permitting disengagement of the latch receiver from the latch interface and, therefore, reconfiguring the seat from the seat configuration to the stowed configuration.

Another embodiment relates to a latching mechanism for a vehicle seat. The latching mechanism may include a latch receiver configured to be coupled to a base of the vehicle seat and positioned to receive a latch interface installed in a vehicle. The latch retainer may be pivotably coupled to the base and positioned to selectively prevent removal of the latch interface from the latch receiver. The latching mechanism may include a connector configured to couple a seat bottom of the vehicle seat to the base and to engage the latch retainer in response to movement of the seat bottom relative to the base. The engagement of the latch retainer may permit disengagement of the latch receiver from the latch interface. The latching mechanism may be positioned to reconfigure the vehicle seat between a seat configuration and a stowed configuration. When transitioning between the vehicle seat from a seat configuration to the stowed configuration, the connector may be positioned to engage with the latch retainer, permitting disengagement of the latch receiver from the latch interface and, therefore, reconfiguring the vehicle seat from the seat configuration to the stowed configuration,

Still another embodiment relates to a latching mechanism for a vehicle seat. The latching mechanism may include a latch receiver configured to be coupled to a base of the vehicle seat and positioned to receive a latch interface installed in a vehicle. The latching mechanism may include a latch retainer pivotably coupled to the base and positioned to selectively prevent removal of the latch interface from the latch receiver. The latching mechanism may include a connector configured to couple a seat bottom of the vehicle seat to the base and to engage the latch retainer in response to movement of the seat bottom relative to the base. The engagement of the latch retainer may permit disengagement of the latch receiver from the latch interface. The latching mechanism may include a lateral stop positioned to prevent lateral movement of the seat bottom relative to the latch interface.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a perspective view of a cabin of the vehicle of FIG. 1 including a seat, according to an exemplary embodiment.

FIG. 3 is a front perspective view of a seat frame assembly and a stowing assembly of the seat of FIG. 2, according to an exemplary embodiment.

FIG. 4 is a rear view of back panel of the seat frame assembly of FIG. 3, according to an exemplary embodiment.

FIG. 5 is a side view of the seat frame assembly and the stowing assembly of the seat of FIG. 3, according to an exemplary embodiment.

FIG. 6 is a detailed perspective view of the stowing system of the seat frame assembly of FIG. 3, according to an exemplary embodiment.

FIG. 7 is another detailed perspective view of the stowing assembly of the seat frame assembly of FIG. 3, according to an exemplary embodiment.

FIG. 8 is a cross-sectional side view of the seat frame assembly and the stowing assembly of FIG. 3, according to an exemplary embodiment.

FIG. 9 is a detailed cross-sectional view of a latching mechanism of the seat assembly of FIG. 8, according to an exemplary embodiment.

FIG. 10 is a detailed view of a first component of the latching mechanism of FIG. 9, according to an exemplary embodiment.

FIG. 11 is a detailed view of a second component of the latching mechanism of FIG. 9, according to an exemplary embodiment.

FIGS. 12-14 are various perspective views of the latching mechanism of FIG. 9 disengaging from a latch interface of the vehicle, according to an exemplary embodiment.

FIGS. 15-20 are various perspective views of the vehicle seat of FIG. 2 transitioning from a seat configuration to a stowed configuration, according to an exemplary embodiment.

FIG. 21 is a detailed view of a latching mechanism of the seat assembly of FIG. 8, according to an exemplary embodiment

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle and Passenger Cabin

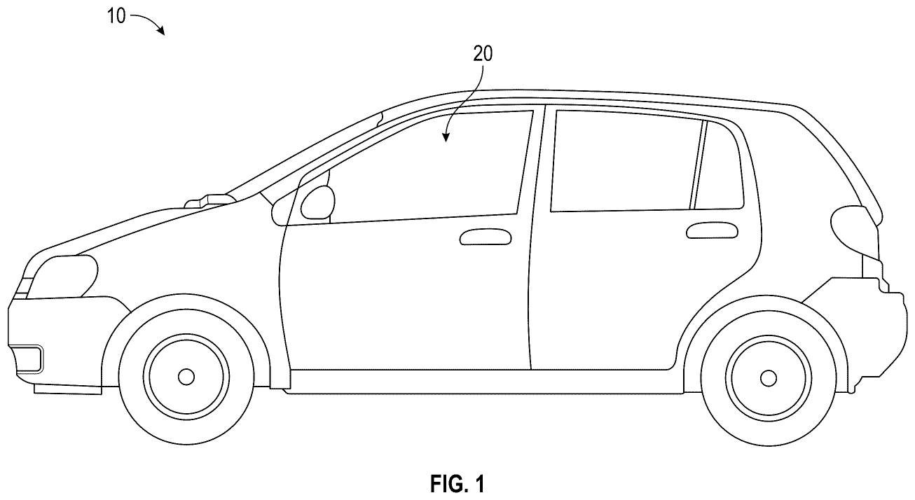

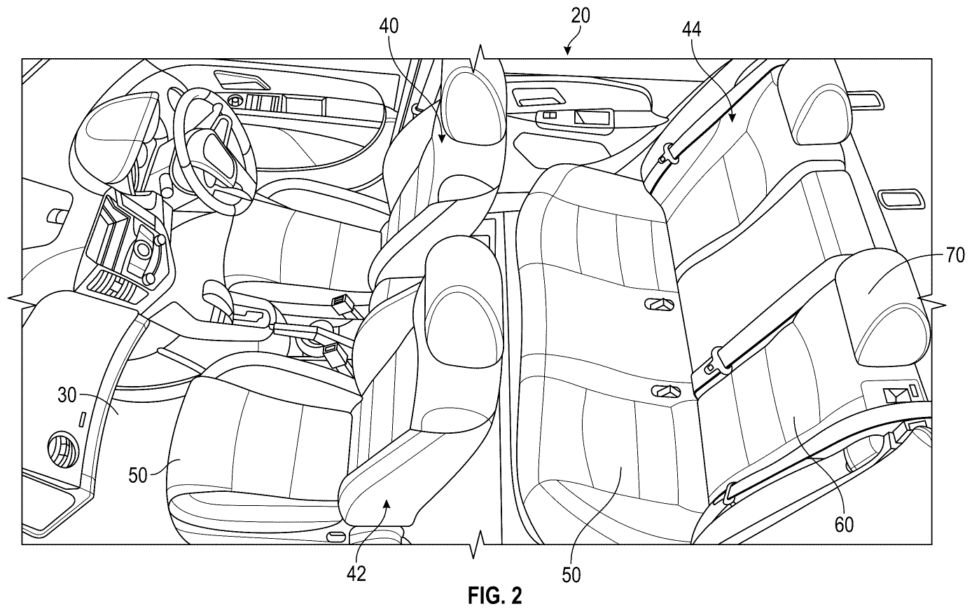

As shown in FIGS. 1 and 2, a vehicle 10 includes an interior cabin, shown as passenger cabin 20. In one embodiment, the vehicle 10 is configured as an on-road vehicle such as a sedan, a sport utility vehicle (“SUV”), a pickup truck, a van, and/or still another type of passenger vehicle. In other embodiments, the vehicle 10 is configured as another type of on-road vehicle such as a semi-truck, a bus, or the like. In still other embodiments, the vehicle 10 is configured as an off-road vehicle such as construction machinery, farming machinery, or the like.

As shown in FIG. 2, the passenger cabin 20 includes a support surface, shown as cabin floor 30, that supports one or more seating assemblies, shown as seats 40, including one or more first seating assemblies, shown as front seats 42, and one or more second seating assemblies, shown as rear seats 44. In some embodiments, the front seats 42 are different than the rear seats 44 (e.g., the front seats 42 recline while the rear seats 44 do not recline). In other embodiments, the front seats 42 and the rear seats 44 are the same or utilize similar components (e.g., to facilitate increased scaling for manufacturing and, therefore, a reduction in production costs). By way of example, the front seats 42 and the rear seats 44 may utilize the same or similar reclining mechanisms. By way of another example, the front seats 42 and the rear seats 44 may utilize a similar track assembly, however, the track assembly for one of the front seats 42 or the rear seats 44 may include one or more additional components (e.g., for added strength, to meet or exceed industry standards, etc.). In some embodiments, the passenger cabin 20 does not include the rear seats 44. In some embodiments, the passenger cabin 20 only includes a single front seat 42. In some embodiments, the rear seats 44 include second row seating and third row seating. In an exemplary embodiment, the seat is manufactured to rest in a design position, in which the seat back is configured to recline from the vertical to a maximum recline angle (e.g., 24.5°).

### Seat Assembly

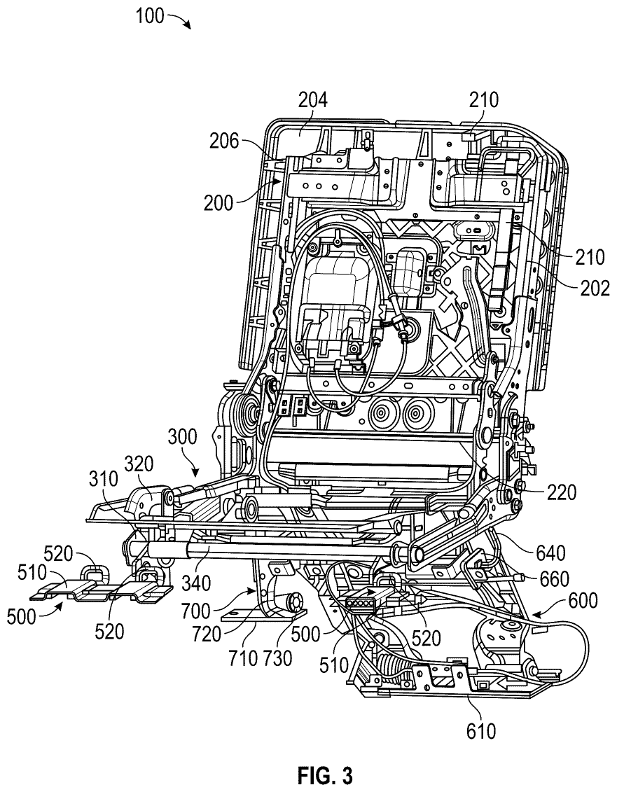

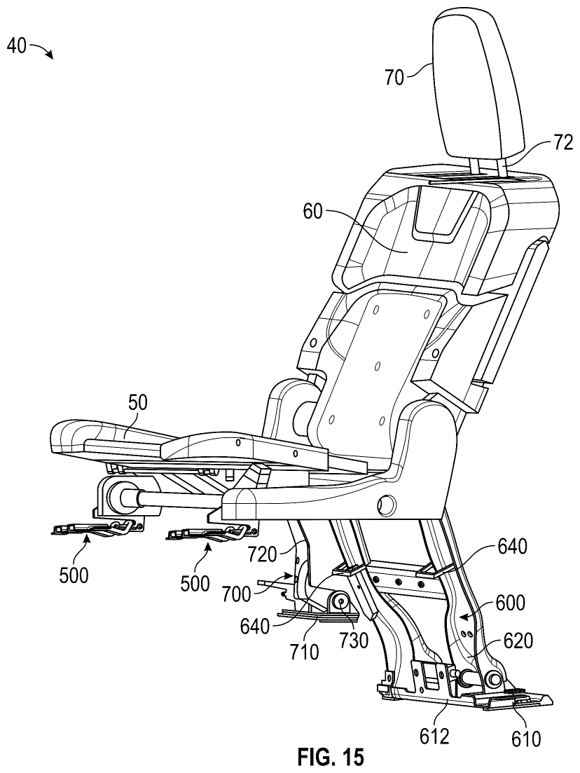

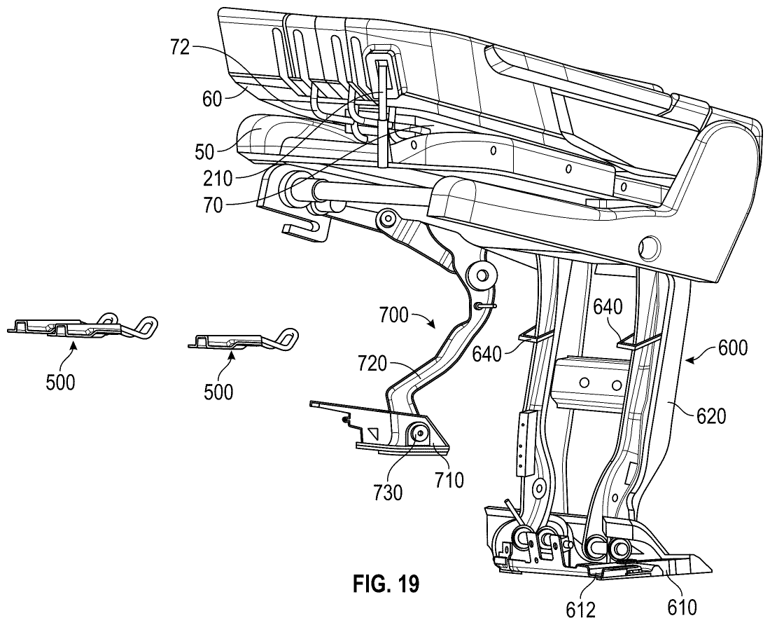

As shown in FIGS. 2-5, 8, and 15-20, each of the seats 40 includes a plurality of padded components and a frame, shown as seat frame assembly 100. As shown in FIGS. 2 and 15-20, the plurality of padded components includes (i) a seat bottom pad, shown as bottom cushion 50, configured to support an occupant's bottom and/or legs, (ii) a seat back pad, shown as seat back cushion 60, configured to support at least a portion of the occupant's torso, and (iii) a head pad or cushion, shown as head restraint 70, configured to support at least a portion of the occupant's head. As shown in FIGS. 3-8 and 15-20, the seat frame assembly 100 includes (i) a first frame portion, shown as upper frame 200, configured to support the seat back cushion 60, (ii) a second frame portion, shown as lower frame 300, configured to support the bottom cushion 50, (iii) a third frame portion, shown as back panel 400, coupled to a rear of the upper frame 200 and configured to support various components of the seat 40 (e.g., a straps, handle, latches, etc.), (iv) a first structural scaffold, shown as rear stowing system 600, coupled to (a) the upper frame 200 and/or the lower frame 300 and (b) a floor structure of the vehicle 10, and (v) a seat transition arm, shown as stowing arm system 700, coupled to the lower frame 300 and the floor structure of the vehicle 10. According to the exemplary embodiment shown in FIGS. 15-20, the rear stowing system 600 and the stowing arm system 700 are configured to facilitate manipulating or reconfiguring the seat 40 to fold and stow the seat 40, as described in greater detail herein.

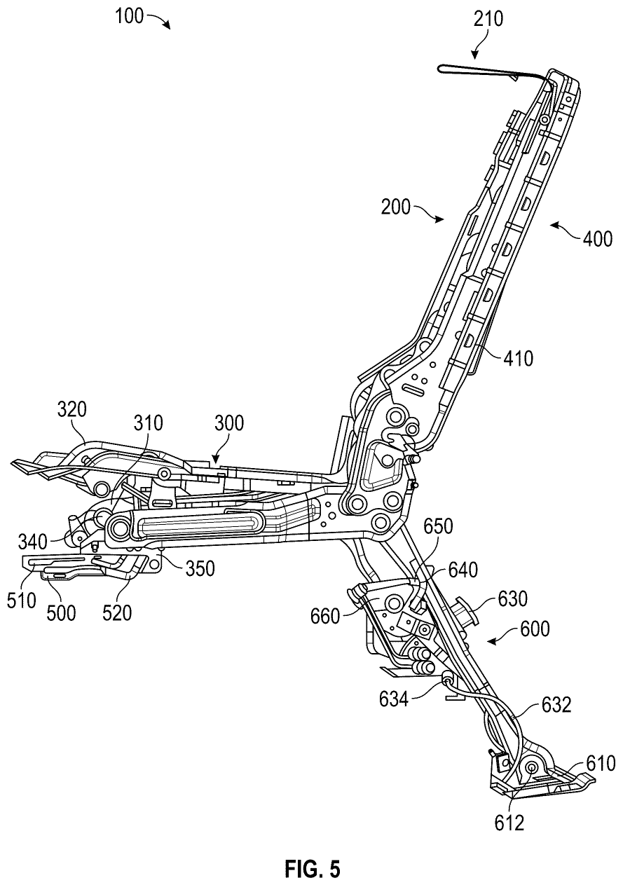

As shown in FIG. 3, the upper frame 200 includes a first frame structure, shown as seat back support 202, that defines a first interface, shown as front frame perimeter 204, around the border of the upper frame 200. The front frame perimeter 204 is further separated into sections via dividers or supports, shown as frame ridges 206, configured to stabilize the internal components of the upper frame 200 and provide structural rigidity. The seat back support 202 is configured to support the seat back cushion 60. As shown in FIGS. 3 and 5, the upper frame 200 includes a first strap loop, shown as front strap 210, positioned among the internal components within the upper frame 200 and extends from a topmost opening of the seat 40 (e.g., proximate the head restraint 70). The front strap 210 provides comfort adjustment of the upper frame 200 and, thereby, the seat back cushion 60. By way of example, an occupant may engage with the front strap 210 to fold down or recline the seat back cushion 60. In one embodiment, the seat back cushion 60 can be pivoted 16 degrees forward from a design or nominal position (e.g., 24.5 degrees from vertical) via the front strap 210. As shown in FIG. 3, the upper frame 200 includes a connecting shaft, as shown as reclining shaft 220, extending between the seat back support 202 of the upper frame 200 and the lower frame 300 to pivotably couple the upper frame 200 and the lower frame 300 together.

As shown in FIGS. 3, 5, 8, and 9, the lower frame 300 includes a second frame structure, shown as base 310, and a third frame structure, shown as seat bottom support 320, movably coupled to the base 310. The seat bottom support 320 is configured to support the bottom cushion 50. As shown in FIGS. 3, 5, 8, and 9, the lower frame 300 includes a shaft, shown as support shaft 340, extending between free, lateral ends of the base 310. As shown in FIGS. 5, 8, 9, and 12-14, the lower frame 300 includes or defines a first portion or component of a first latching mechanism, shown as latch receiver 350, positioned to engage with a latch interface (e.g., receive a striker secured to the base of the vehicle interior). The latch receiver 350 includes (i) an extending arm, shown as latch arm 352, (ii) an engagement guide or ridge, shown as latch arm guide 354, (iii) a curved cavity, shown as latch cavity 356, and (iv) a fastener, shown as latch fastener 358, coupling the latch receiver 350 to the base 310.

As shown in FIGS. 5, 8, 9, and 12-14, the latch receiver 350 engages with a first latch interface, shown as striker 500, coupled to the floor structure of the vehicle 10. The striker 500 includes (i) a bracket, shown as mounting plate 510, configured to facilitate securing the striker 500 to the floor structure of the vehicle 10 and (i) a retainer, shown as retaining bar 520. The mounting plate 510 defines one or more ridges, shown as ridges 512, which defines recesses, as striker bar recesses 514. Portions of the retaining bar 520 are received within the striker bar recesses 514 to secure the retaining bar 520 in place with the mounting plate 510.

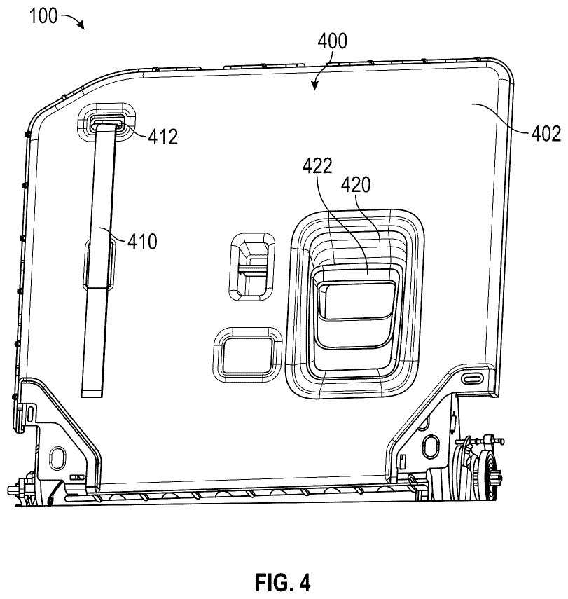

As shown in FIG. 4, the back panel 400 includes a fourth frame structure, shown as back plate 402, coupled to a rear side of the upper frame 200. The seat 40 includes a second strap, shown as back strap 410, extending through an aperture, shown as strap aperture 412, defined by the back plate 402. According to an exemplary embodiment, pulling on the back strap 410 is configured to facilitate folding the upper frame 200 and stowing the seat 40. As shown in FIG. 4, the back plate 402 further includes a handle region, shown as handle structure 420. The handle structure 420 includes a hand grip, shown as handle 422, configured to facilitate movement of the seat 40 when stowing or deploying the seat 40.

As shown in FIGS. 3 and 5-8, the rear stowing system 600 includes (i) a main plate structure, shown as base anchor plate 610, (ii) one or more first legs, shown as legs 620, pivotably coupled to and extending between (a) the base anchor plate 610 and (b) the upper frame 200 and/or the lower frame 300, (iii) a connector, shown as support 630, extending between the legs 620, (iv) one or more second latch interfaces, shown as strikers 640, positioned along the legs 620, and (v) one or more second latching mechanisms including (a) a first latching portion or component, shown as latch retainer 650, and (b) a second latching portion or component, shown as latch mount 660, coupling the latch retainer 650 to the floor or support structure of the vehicle 10.

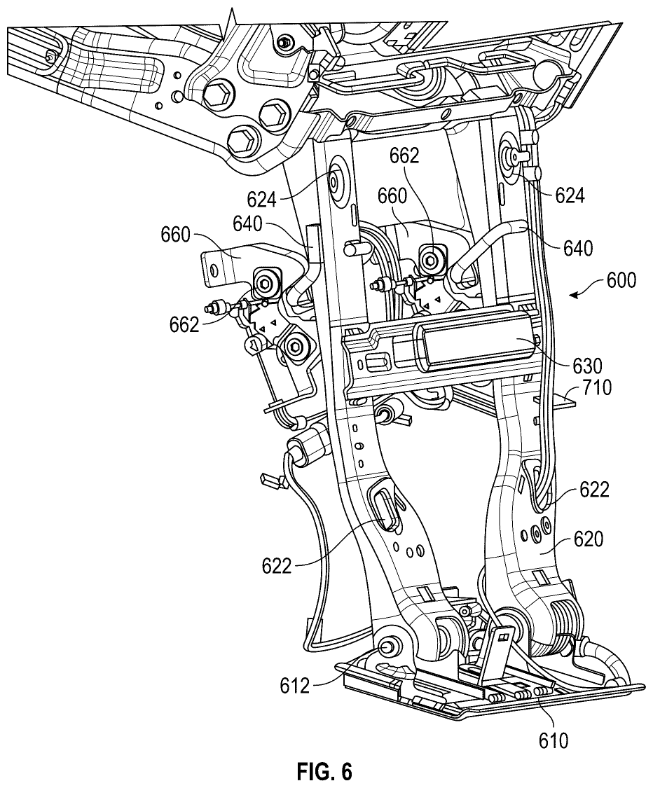

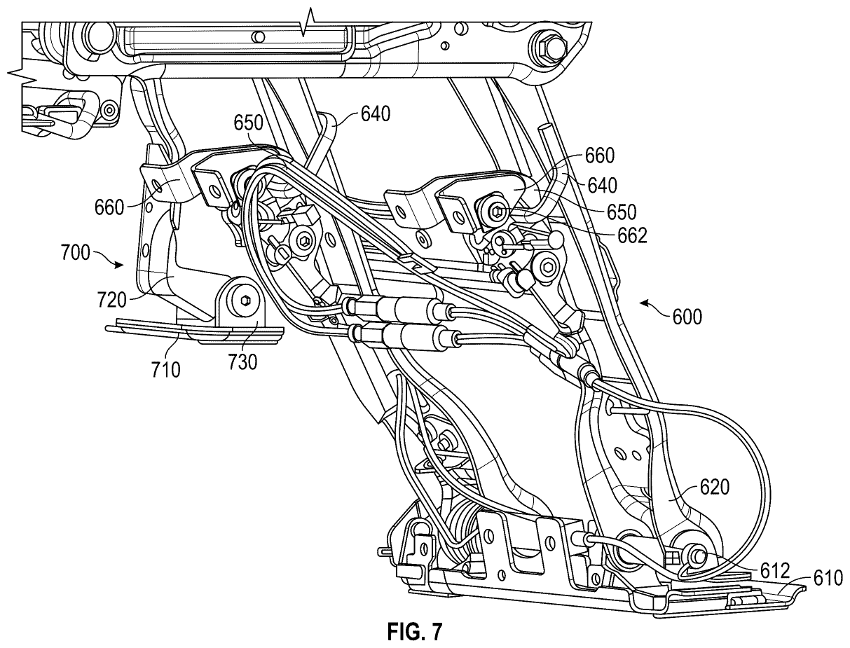

According to an exemplary embodiment, the base anchor plate 610 is configured to secure the seat 40 to the floor structure of the vehicle 10 (e.g., within a recess in the trunk or rear storage area). As shown in FIGS. 3 and 5-8, the base anchor plate 610 includes fasteners, shown as base anchor fasteners 612, pivotably coupling the legs 620 to the base anchor plate 610. As shown in FIG. 6, the legs 620 define apertures, shown as apertures 622, configured to receive and guidewires, tubing, or similar components required to power devices placed within the seat 40. As shown in FIGS. 5-8, the strikers 640 engage with and are received by the second latching mechanisms (e.g., the latch mount 660, the latch retainer 650) to stabilize and secure the seat 40 in a seat configuration. As shown in FIGS. 6 and 7, the latch mount 660 includes a fastener, shown as mount fastener 662, pivotably coupled the latch retainer 650 to the latch mount 660 to allow the latch retainer 650 to rotate and engage or disengage with the striker 640.

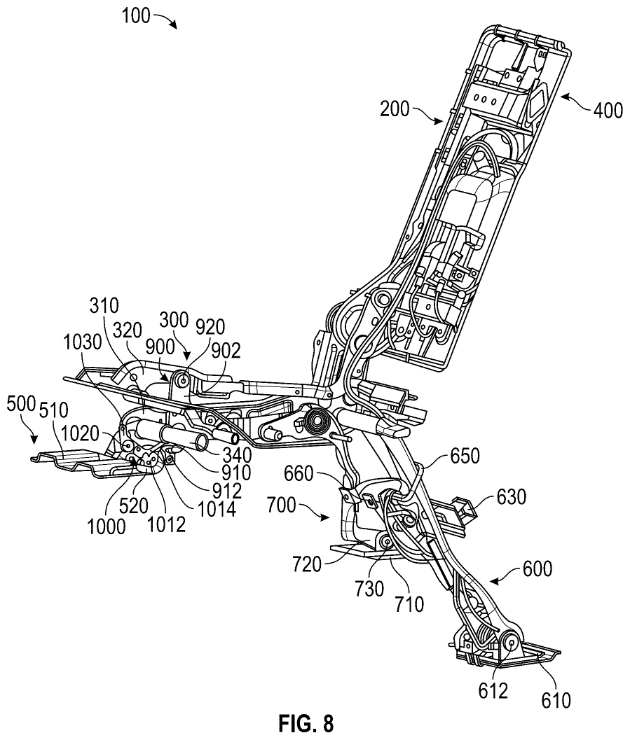

As shown in FIGS. 7 and 8, the stowing arm system 700 includes (i) a second base plate, shown as secondary anchor plate 710, (ii) a second leg, shown as secondary leg 720, pivotably coupled to and extending between (a) the secondary anchor plate 710 and (b) the base 310 of the lower frame 300, and (iii) a fastener, shown as secondary anchor fastener 730, pivotably coupling the secondary leg 720 to the secondary anchor plate 710. The rear stowing system 600 functions in conjunction with the stowing arm system 700 to secure the seat 40 to the floor or support structure of the vehicle 10, and well as facilitate repositioning position the seat 40 between a seat configuration and a stowed configuration.

As shown in FIGS. 6 and 7, the latch retainers 650 engage with a rearmost edge of the strikers 640. However, when a significant load is applied to the seat 40 in a rearward direction, the engagement strikers 640 may become disengaged from the latch retainers 650 (e.g., due to deflection). As a result, the seat may to become disengaged from the striker 500 without additional supports. To combat such inadvertent disengagement, as shown in FIGS. 8, 9, and 11-14, a second portion or component (e.g., a blocker plate, a latch blocker, etc.) of the first latching mechanism, shown as latch retainer 1000, is pivotably coupled to the base 310 and is positioned to selective enclose the latch cavity 356 of the latch receiver 350 to prevent disengagement or removal of the retaining bar 520 of the striker 500 from the first latching mechanism (e.g., the latch receiver 350 and the latch retainer 1000). In some embodiments, the seat 40 includes a pair of latch retainers 1000, one positioned proximate each latch receiver 350. According to an exemplary embodiment, the latch retainer 1000 is configured to (i) prevent the strikers 500 and the strikers 640 from inadvertently disengaging from the first latching mechanisms (e.g., the latch receivers 350, the latch retainer 1000) and the second latching mechanisms (e.g., the latch retainers 650, the latch mounts 660) when an impact to the vehicle 10 occurs and (ii) permit the seat frame assembly 100 to selectively transition to a stowed configuration (e.g., when the front strap 210 and/or the back strap 410 are engaged by the occupant). Further details regarding the relationship and interactions between the various components of the latching mechanisms are provided in greater detail herein.

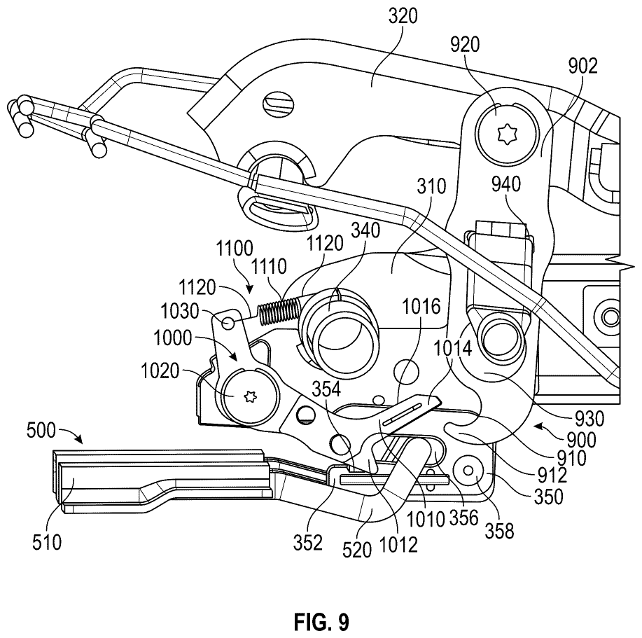

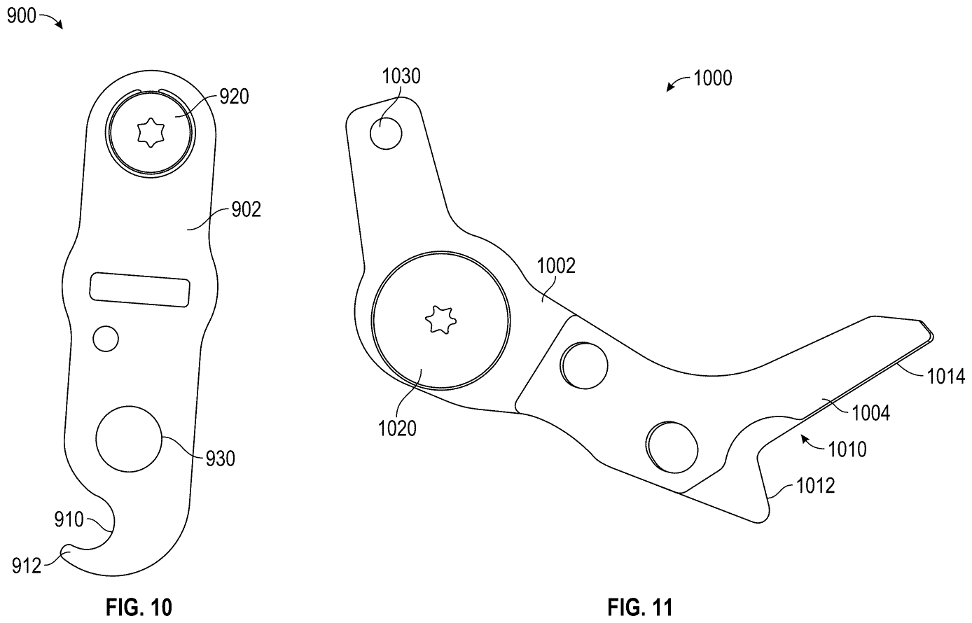

As shown in FIGS. 9, 10, and 12-14, the seat frame assembly 100 includes a connector plate, shown as hooked arm 900, extending between and movably (e.g., pivotably) coupling the seat bottom support 320 to the base 310. The hooked arm 900 has a main body, shown as plate body 902, defining a circular cavity, shown as hook cavity 910, at the lower end thereof, which defines a protrusion or finger, shown as hook 912, configured to engage with features of the latch retainer 1000. The plate body 902 defines a plurality of apertures including (i) a first fastener opening, shown as first fastening aperture 920, and (ii) a second fastener opening, shown as second fastening aperture 930. The first fastening aperture 920 and second fastening aperture 930 are configured to receive fasteners to pivotably couple the hooked arm 900 to the seat bottom support 320 to the base 310, respectively.

As shown in FIGS. 9, 11, and 12-14, the latch retainer 1000 is includes (i) a first blocker plate, shown as base blocker plate 1002, and (ii) a second blocker plate, shown as top blocker plate 1004. In some embodiments, the base blocker plate 1002 and the top blocker plate 1004 are welded together. In some embodiments, the base blocker plate 1002 and the top blocker plate 1004 are fastened together with fasteners. In some embodiments, the latch retainer 1000 has a unitary structure.

As shown in FIGS. 9, 11, and 12-14, the latch retainer 1000 includes an engagement arm, shown as blocker arm 1010, positioned to engage with the retaining bar 520 of the striker 500. The blocker arm 1010 includes a pointed protrusion, shown as triangular engagement protrusion 1012, configured to interact with the interior surface of the retaining bar 520, and an extending arm, shown as interior arm face 1014, configured to engage with the topmost surface of the retaining bar 520. The triangular engagement protrusion 1012 and the interior arm face 1014 are positioned to prevent longitudinal movement of the seat bottom relative to the striker 500. The latch retainer 1000 defines a first aperture, shown as blocker fastener aperture 1020, configure to receive a fastener, to pivotably couple the latch retainer 1000 to the base 310. The latch retainer 1000 defines a second aperture, shown as spring aperture 1030, configured to engage with a biasing member.

As shown in FIGS. 9 and 12-14, the seat frame assembly 100 includes a biasing member, shown as spring 1100, configured to bias movement of the latch retainer 1000 (e.g., biased to close the latch cavity 356 of the latch receiver 350). The spring 1100 includes a series of coils, shown as coil body 1110, configured to maintain tension within the latch retainer 1000, and a pair of legs, shown as spring legs 1120, configured to engage with the spring aperture 1030 of the latch retainer 1000 and the support shaft 340.

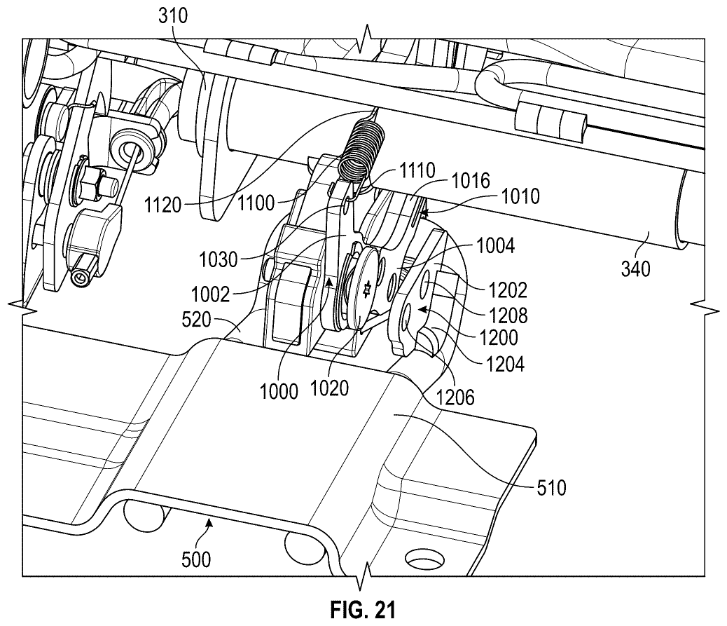

As shown in FIG. 21, the seat frame assembly 100 includes a lateral stop, shown as cross-car blocker plate 1200, configured to prevent lateral movement of the seat bottom relative to the retaining bar 520. The cross-car blocker plate 1200 includes a first protrusion, shown as plate protrusion 1202, and a secondary latch retainer, shown as plate retainer 1204, configured to engage with the with the retaining bar 520 such that a face of the plate protrusion 1202 abuts the retaining bar 520. In some embodiments, the cross-car blocker plate 1200 is fixed (e.g., welded) to the retaining bar 520. In such embodiments, the cross-car blocker plate 1200 may be configured to selectively engage with the latch retainer 1000 to prevent or limit lateral movement of the lower frame 300. As shown in FIG. 21, the cross-car blocker plate 1200 includes apertures, shown as first aperture 1206 and second aperture 1208. In some embodiments, the first aperture 1206 and/or the second aperture 1208 are configured to receive fasteners to couple the cross-car blocker plate 1200 to the latch retainer 1000. In such embodiments, the cross-car blocker plate 1200 may be configured to selectively engage with the retaining bar 520 to prevent or limit lateral movement of the lower frame 300.

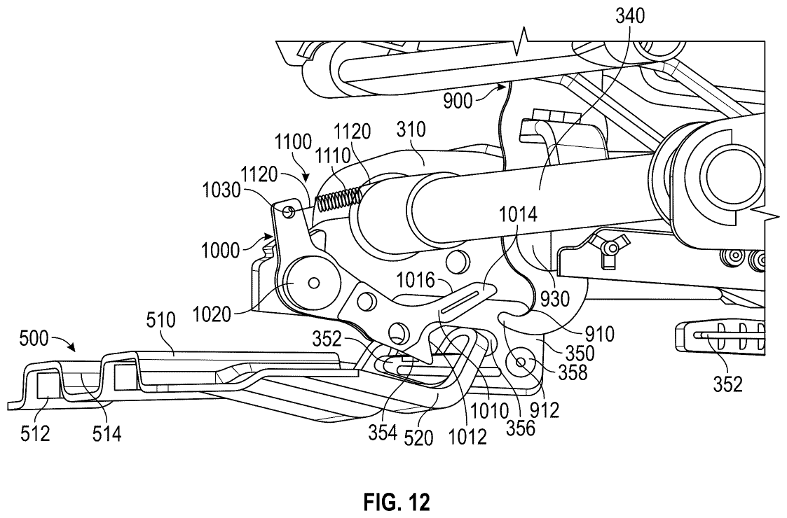

As shown in FIGS. 9, 12, and 21, when the seat 40 is positioned in an upright, seat configuration, the retaining bar 520 is received within the latch receiver 350 and the retaining bar 520 is secured therein by (i) the triangular engagement protrusion 1012 and the interior arm face 1014 of the latch retainer 1000 and (ii) the plate protrusion 1202 and the plate retainer 1204 of the cross-car blocker plate 1200. As shown in FIGS. 9 and 12, the triangular engagement protrusion 1012 engages with the latch arm guide 354, securing the seat in place. The spring 1100 biases the latch retainer 1000 in place when no load is applied thereto (e.g., engagement with the hooked arm 900 is absent). According to an exemplary embodiment, the hooked arm 900 is positioned in a vertical orientation when the seat 40 is in the seat configuration, where the hook 912 does not interface with the interior arm face 1014, such the triangular engagement protrusion 1012 remains in contact with the latch arm guide 354. As a result, the engagement of the latch receiver 350 with the latch retainer 1000 prevents the seat frame assembly 100 from disengaging from the striker 500 (e.g., during an impact). As shown in FIG. 21, the plate protrusion 1202 and the plate retainer 1204 engage with the retaining bar 520, securing the seat 40 laterally in place. The plate protrusion 1202 engages with a portion of the retaining bar 520 opposite the mounting plate 510, and the plate retainer 1204 engages with a portion of the retaining bar 520 adjacent to a connection point of the mounting plate 510 and the retaining bar 520. As a result, the engagement of the cross-car blocker plate 1200 with the retaining bar 520 prevents the latch receiver 350 from moving relative to the striker 500 (e.g., laterally, side-to-side).

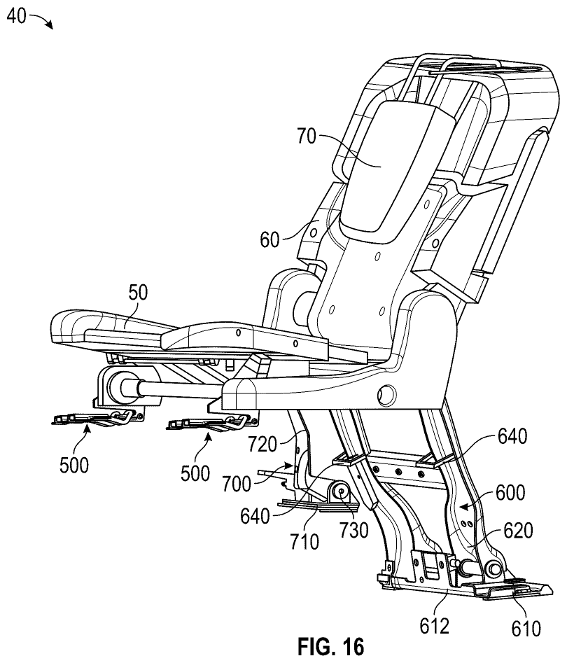

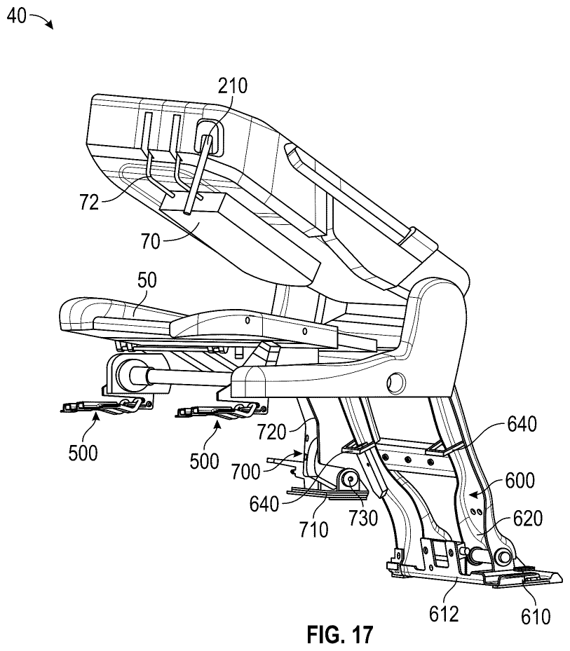

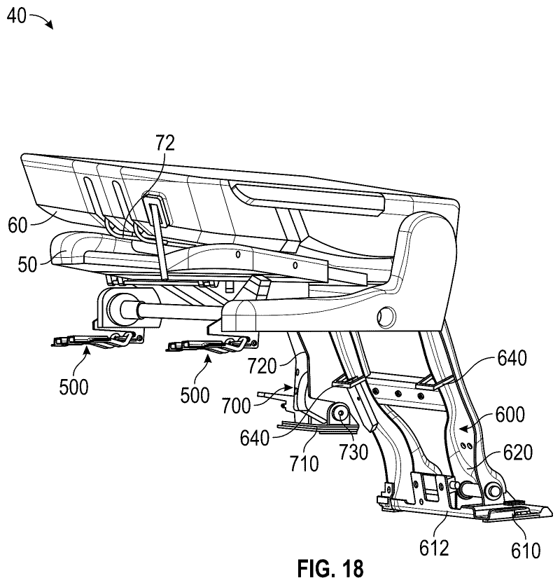

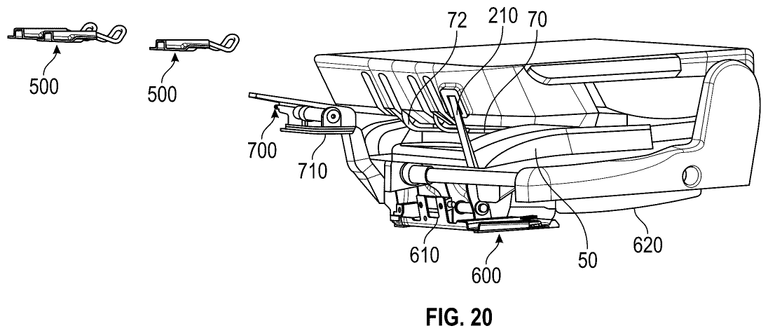

As shown in FIGS. 15-20, the seat 40 is configured to fold from a seat configuration (as shown in FIG. 15) to a stowed configuration (as shown in FIG. 20) where the seat 40 stows rearward of and at least partially below the secondary anchor plate 710 when the back strap 410 is pulled. In an exemplary embodiment, to fold the seat back cushion 60, an occupant may pull on the back strap 410, therefore folding the head restraint 70 (as shown in FIG. 16) and releasing the recliner mechanism coupled to the reclining shaft 220. The release of the recliner mechanism permits folding the seat back cushion 60 (as shown in FIGS. 17 and 18). As shown in FIGS. 15-18, when the occupant manipulates the seat back cushion 60 to fold, the seat bottom support 320 and, thereby, the bottom cushion 50 pivots or drops relative to the base 310 via the hooked arm 900 and shifts rearward towards the seat back cushion 60. The movement of the seat bottom support 320 and the bottom cushion 50 relative to the base 310 facilitates disengagement of the latch retainer 1000.

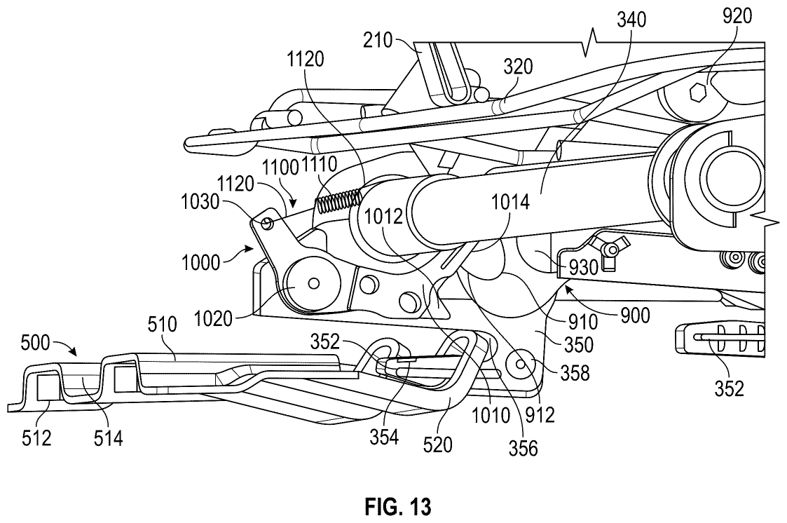

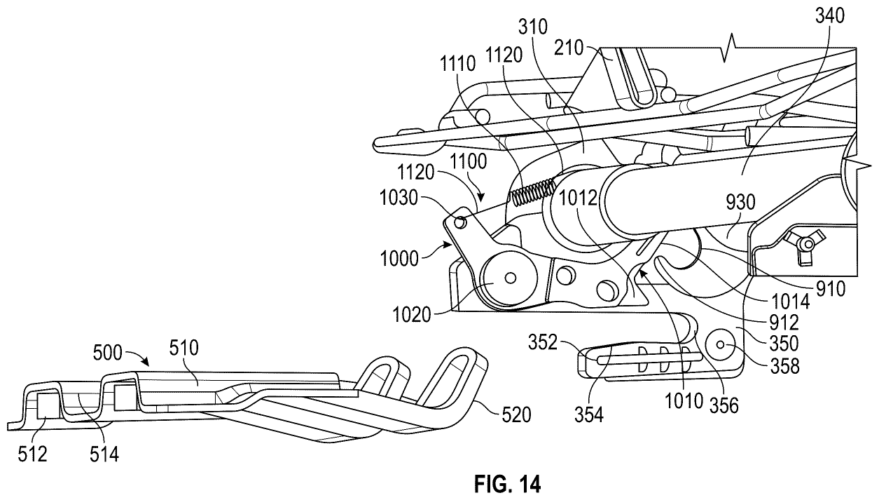

As shown in FIGS. 12-18, as the seat back cushion 60 is folded and the bottom cushion 50 shifts (e.g., downward, rearward, etc.), the hook 912 pivots about the second fastening aperture 930 to engage with the interior arm face 1014 of the latch retainer 1000. As shown in FIGS. 13 and 14, engagement of the interior arm face 1014 expands the spring 1100, allowing the latch retainer 1000 to rotate about the blocker fastener aperture 1020. As a result, contact between the triangular engagement protrusion 1012 and the latch arm guide 354 is removed, unlatching the latch arm 352 from the latch retainer 1000. As a result, as shown in FIGS. 13, 14, and 18-20, the latch receivers 350 can be disengaged from retaining bars 520, and the latch retainers 650 can be disengaged striker 640 to facilitate stowing of the seat 40.

As shown in FIGS. 18-20, once the seat back cushion 60 is folded, the seat 40 may then be pulled rearward (e.g., using the handle 422) where (a) the secondary leg 720 pivots about secondary anchor fastener 730 and (b) the legs 620 pivot about the base anchor fasteners 612, swinging and repositioning the seat 40 rearwards into the stowed configuration (as shown in FIG. 20).

Conversely, as shown in FIGS. 15-20, the seat 40 is configured to unfold and return to a seat configuration when engaging with the back strap 410. In an exemplary embodiment, to unstow the seat 40, the occupant lifts the seat 40 frontward. The frontward movement pivots the legs 620 about the base anchor fasteners 612 and the secondary leg 720 about secondary anchor fastener 730, rotating the seat 40 towards the strikers 500 and the latch retainers 650. The latch arm 352 engages with the retaining bar 520 and slides along the latch cavity 356, and the strikers 640 engage with the latch retainers 650.

As the seat back cushion 60 is unfolded, the bottom cushion 50 shifts upward and frontward away from the seat back cushion 60. As shown in FIGS. 12-14, the retaining bar 520 is further secured within the latch cavity 356 by the latch retainer 1000 as the hooked arm 900 pivots with the bottom cushion 50. As a result, (i) the spring 1100 returns to its original, nominal state, (ii) the hooked arm 900 disengages from the latch retainer 1000, causing the latch retainer 1000 to pivot about the blocker fastener aperture 1020, and (iii) the triangular engagement protrusion 1012 engages with the latch arm guide 354, closing the latch cavity 356 and securing the retaining bar 520 between the latch receiver 350 and the latch retainer 1000, thereby securing the seat 40 in place. According to an exemplary embodiment, the hooked arm 900 returns to a vertical orientation where the hook 912 does not interface with the interior arm face 1014, allowing the triangular engagement protrusion 1012 to remain in contact with the latch arm guide 354. As shown in FIGS. 15 and 16, to completely unfold the seat back cushion 60, the occupant may pull the back strap 410 to lift the seat back cushion 60 to the nominal position (e.g., 24.5 degrees from vertical). The head restraint 70 may then be manually lifted to restore the upright seat configuration.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A vehicle seat comprising:
a seat bottom assembly including:
a base;
a seat bottom;
a connector movably coupling the seat bottom to the base; and
a latching mechanism coupled to the base and configured to engage with a latch interface installed in a vehicle, the latching mechanism including:
a latch receiver positioned to receive the latch interface; and
a latch retainer pivotably coupled to the base, the latch retainer positioned to selectively prevent removal of the latch interface from the latch receiver; and
a seat back pivotably coupled to the base;
wherein the vehicle seat is reconfigurable between a seat configuration and a stowed configuration; and
wherein, when transitioning the vehicle seat from the seat configuration to the stowed configuration, the seat bottom moves relative to the base, causing the connector to engage with the latch retainer, permitting disengagement of the latch receiver from the latch interface and, therefore, reconfiguring the seat from the seat configuration to the stowed configuration.

2. The vehicle seat of claim 1, further comprising a lateral stop positioned to prevent lateral movement of the seat bottom relative to the latch interface.

3. The vehicle seat of claim 2, further comprising the latch interface, wherein the lateral stop is coupled to the latch interface and configured to selectively engage with the latching mechanism.

4. The vehicle seat of claim 2, wherein the lateral stop is coupled to the latching mechanism and configured to selectively engage with the latch interface.

5. The vehicle seat of claim 1, wherein, when transitioning the vehicle seat from the stowed configuration to the seat configuration, the seat bottom moves relative to the base, causing the connector to disengage from the latch retainer, permitting engagement of the latch receiver with the latch interface and, therefore, reconfiguring the seat from the stowed configuration to the seat configuration.

6. The vehicle seat of claim 1, wherein the latch receiver has a latch guide and defines a latch cavity configured to receive a retaining bar of the latch interface.

7. The vehicle seat of claim 6, wherein the latch retainer includes a first protrusion configured to engage the latch guide when the latch interface is received within the latch cavity.

8. The vehicle seat of claim 7, wherein the connector has a second protrusion configured to engage a portion of the latch retainer during movement of the seat bottom relative to the base.

9. The vehicle seat of claim 1, wherein the latching mechanism includes a biasing member in engagement with the latch retainer and a support shaft of the base.

10. The vehicle seat of claim 9, wherein the biasing member is positioned to bias the latch retainer toward a first position from a second position, wherein the latch retainer engages with a retaining bar of the latch interface to prevent removal of the latch interface from the latch receiver when the latch retainer is in the first position, and wherein the latch retainer disengages the retaining bar when the latch retainer is in the second position, facilitating removal of the latch interface from the latch receiver.

11. A latching mechanism for a vehicle seat, comprising:
a latch receiver configured to be coupled to a base of the vehicle seat and positioned to receive a latch interface installed in a vehicle;
a latch retainer pivotably coupled to the base and positioned to selectively prevent removal of the latch interface from the latch receiver;
a connector configured to couple a seat bottom of the vehicle seat to the base and to engage the latch retainer in response to movement of the seat bottom relative to the base, the engagement permitting disengagement of the latch receiver from the latch interface,
wherein the latching mechanism is positioned to reconfigure the vehicle seat between a seat configuration and a stowed configuration; and
wherein, when transitioning between the vehicle seat from the seat configuration to the stowed configuration, the connector is positioned to engage with the latch retainer, permitting disengagement of the latch receiver from the latch interface and, therefore, reconfiguring the vehicle seat from the seat configuration to the stowed configuration.

12. The latching mechanism of claim 11, further comprising a lateral stop positioned to prevent lateral movement of the seat bottom relative to the latch interface.

13. The latching mechanism of claim 12, further comprising the latch interface, wherein the lateral stop is coupled to the latch interface and configured to selectively engage with the latching mechanism.

14. The latching mechanism of claim 13, wherein the lateral stop is coupled to the latching mechanism and configured to selectively engage with the latch interface.

15. The latching mechanism of claim 11, wherein the latch receiver has a latch guide and defines a latch cavity configured to receive a retaining bar of the latch interface.

16. The latching mechanism of claim 15, wherein the latch retainer includes a first protrusion configured to engage the latch guide when the latch interface is received within the latch cavity.

17. The latching mechanism of claim 16, wherein the connector has a second protrusion configured to engage a portion of the latch retainer during movement of the seat bottom relative to the base.

18. The latching mechanism of claim 11, wherein the latching mechanism includes a biasing member in engagement with the latch retainer and a support shaft of the base.

19. The latching mechanism of claim 18, wherein the biasing member is positioned to bias the latch retainer toward a first position from a second position, wherein the latch retainer engages with a retaining bar of the latch interface to prevent removal of the latch interface from the latch receiver when the latch retainer is in the first position, and wherein the latch retainer disengages the retaining bar when the latch retainer is in the second position, facilitating removal of the latch interface from the latch receiver.

20. A latching mechanism for a vehicle seat, the latching mechanism comprising:
a latch receiver configured to be coupled to a base of the vehicle seat and positioned to receive a latch interface installed in a vehicle;
a latch retainer pivotably coupled to the base and positioned to selectively prevent removal of the latch interface from the latch receiver;
a connector configured to couple a seat bottom of the vehicle seat to the base and to engage the latch retainer in response to movement of the seat bottom relative to the base, the engagement permitting disengagement of the latch receiver from the latch interface; and
a lateral stop positioned to prevent lateral movement of the seat bottom relative to the latch interface.
